(19) United States
(12) Patent Application Publication
(10) Pub. No.: US 2021/0231003 A1
(43) Pub. Date: Jul. 29, 2021

(54) WELLBORE LEAK DETERMINATION

(71) Applicant: Saudi Arabian Oil Company, Dhahran (SA)

(72) Inventors: Ayman Alkhalaf, Dhahran (SA); Ibrahim Mohamed El-Zefzafy, Udhailiyah (SA)

(21) Appl. No.: 16/774,762

(22) Filed: Jan. 28, 2020

(51) Int. Cl. E21B 47/10; E21B 47/06; G06N 20/00; G06F 17/14

(52) U.S. Cl. CPC E21B 47/1025; E21B 47/1005; G06F 17/14; G06N 20/00; E21B 47/065

(57) ABSTRACT

A computer system receives data obtained from multiple hydrocarbon wells. The data includes a first set of downhole temperature logs recorded before detection of one or more wellbore leaks in the multiple hydrocarbon wells. A second set of downhole temperature logs is recorded after detection of the one or more wellbore leaks. The computer system extracts multiple features from the data to generate an N-dimensional feature space. The computer system performs dimensionality reduction on the N-dimensional feature space to generate an M-dimensional feature space, wherein M is less than N. The computer system generates one or more machine learning models trained to determine the one or more wellbore leaks in the multiple hydrocarbon wells based on the M-dimensional feature space.

### TECHNICAL FIELD

This description relates generally to hydrocarbon wells, for example, to determining a leak in a wellbore of a hydrocarbon well using machine learning.

### BACKGROUND

Hydrocarbon recovery from oil wells poses a challenge in the presence of leaks. A leak can develop at a location on a wellbore of a hydrocarbon well. For example, a leak can develop in a tubing or a casing. The leak causes fluids to leak into areas where pressure is less. Such a leak affects the integrity of the hydrocarbon well, and poses challenges to hydrocarbon recovery and a potential danger to the environment.

### SUMMARY

A computer system receives data obtained from multiple hydrocarbon wells. The data includes a first set of downhole temperature logs recorded before detection of one or more wellbore leaks in the hydrocarbon wells. A second set of downhole temperature logs is recorded after detection of the one or more wellbore leaks. The computer system extracts multiple features from the data to generate an N-dimensional feature space. The computer system performs dimensionality reduction on the N-dimensional feature space to generate an M-dimensional feature space, wherein M is less than N. The computer system generates one or more machine learning models trained to determine the one or more wellbore leaks in the hydrocarbon wells based on the M-dimensional feature space.

In some implementations, the features include, for each downhole temperature log of the first set of downhole temperature logs and the second set of downhole temperature logs, an absolute energy determined using the downhole temperature log.

In some implementations, the features include, for each downhole temperature log of the first set of downhole temperature logs and the second set of downhole temperature logs, an absolute sum of temperature changes determined using the downhole temperature log.

In some implementations, the features include, for each downhole temperature log of the first set of downhole temperature logs and the second set of downhole temperature logs, an aggregation of an autocorrelation function determined using the downhole temperature log.

In some implementations, the features include, for each downhole temperature log of the first set of downhole temperature logs and the second set of downhole temperature logs, a complexity metric of the downhole temperature log.

In some implementations, the features include, for each downhole temperature log of the first set of downhole temperature logs and the second set of downhole temperature logs, a Fourier transform performed on the downhole temperature log.

In some implementations, the computer system extracts one or more features from a third set of downhole temperature logs obtained from a hydrocarbon well. The one or more features indicate a location of a wellbore leak in the hydrocarbon well. The computer system determines the location of the wellbore leak using the one or more machine learning models based on the one or more features.

### BRIEF DESCRIPTION OF THE DRAWINGS

FIG. 1 illustrates a wellbore leak determination method.

FIG. 2 illustrates a visualization of principal component analysis.

FIG. 3 illustrates a process for wellbore leak determination.

### DETAILED DESCRIPTION

The implementations disclosed provide methods, apparatus, and systems for wellbore leak determination using machine learning. The implementations perform automatic wellbore leak determination using downhole temperature logs in a methodology based on machine learning. A dedicated machine learning model is constructed that automatically pinpoints a wellbore leak in a tubing or a casing using the temperature logs. The machine learning model is trained on multiple surveys to uncover the patterns that indicate a wellbore leak. The machine learning model further enables an automated advisory system to pinpoint wellbore leak locations.

Among other benefits and advantages, the methods provide a flexible and integrated framework for wellbore leak determination. The implementations analyze temperature logs using machine learning and novel feature extraction techniques. Moreover, the feature extraction techniques disclosed enable multiple other cases within the petroleum industry. For example, the implementations can be used to create an assessment phase that explores the potential of other models in the domain of temperature log analysis. The implementations can further serve as add-on methods in temperature log acquisition systems. Moreover, oil and gas companies can use the implementations for automating the process of analyzing historical temperature surveys.

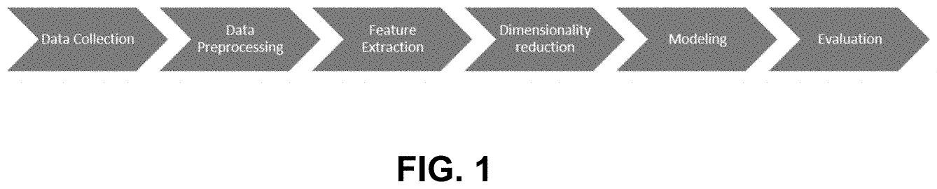

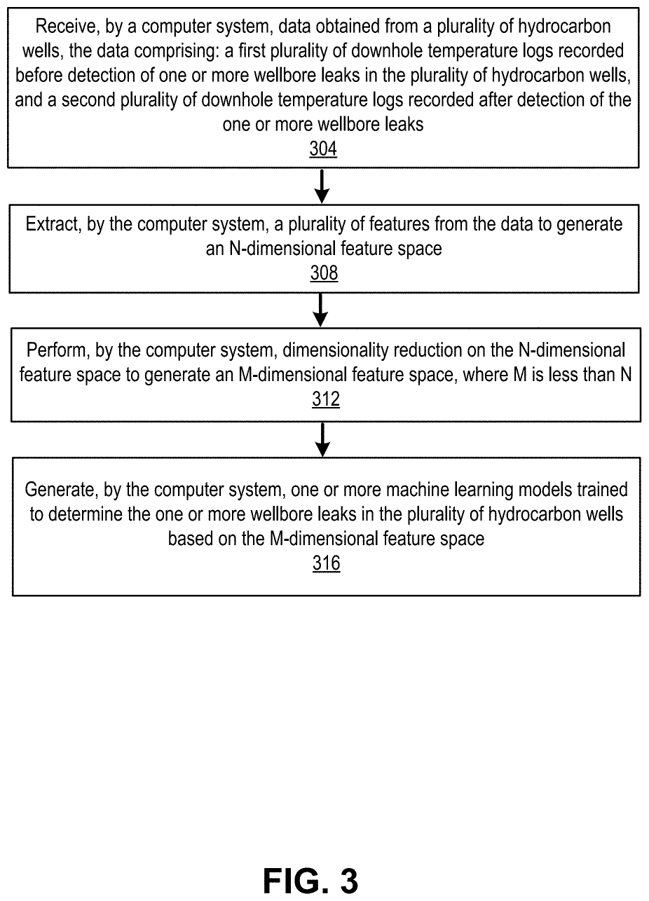

FIG. 1 illustrates a wellbore leak determination method. The implementations described use historical temperature logs to build one or more machine learning models that aid in wellbore leak detection using data-driven technologies. To build and train the machine learning models, a computer system interfaces with a database of historical downhole temperature logs to acquire the needed data. Such a computer system is described in more detail with reference to FIG. 3. The data is processed in a manner that enables the data to be digestible by a machine-learning pipeline.

In the Data Collection step illustrated in FIG. 1, a computer system receives data obtained from multiple hydrocarbon wells. An oil reservoir or hydrocarbon reservoir refers to a subsurface pool of hydrocarbons contained in porous or fractured rock formations. A hydrocarbon well refers to a boring in the Earth that is designed to bring petroleum oil hydrocarbons and natural gas to the surface. Multiple hydrocarbon wells can be bored in a reservoir. The data received by the computer system includes a first set of downhole temperature logs recorded before detection of one or more wellbore leaks in the multiple hydrocarbon wells. The data received by the computer system also includes a second set of downhole temperature logs recorded after detection of the one or more wellbore leaks. In some implementations, a wellbore leak refers to a leak of fluids in a tubing or casing of a wellbore of a hydrocarbon well. In other implementations, a wellbore leak refers to an inadvertent hydraulic connection between geologically isolated zones along the hydrocarbon well due to deficiencies in design or construction and loss of integrity over time. The data collection is accomplished through interfacing the computer system with the database and configuring a data acquisition software program.

In the Data Preprocessing step illustrated in FIG. 1, the computer system interfaces with the database to examine the first set of downhole temperature logs and the second set of downhole temperature logs. The computer system examines the historical wellbore leak workovers. When a wellbore develops a leak or casing corrosion, a workover is performed to identify the source depth and terminate the leak by adding a sealing material (for example, cement) into perforations to seal the leak. The temperature logs that preceded the wellbore leaks (first set of downhole temperature logs) are labeled for training the machine learning models. Labeling is similarly performed for the temperature logs (second set of downhole temperature logs) that followed the workovers. The labeling enables the machine learning models to be used for supervised learning techniques in the Modeling step illustrated in FIG. 1.

In the Feature Extraction step illustrated in FIG. 1, the computer system extracts multiple features from the data to generate an N-dimensional feature space. For example, N can be 26. In some implementations, the computer system reduces redundancy in the training data (the received data obtained from the hydrocarbon reservoir) by transforming the training data into a reduced set of features (a feature vector). For example, in the Feature Extraction step, the computer system applies mathematical operations to the temperature logs to extract attributes (features). The feature vector contains the relevant information from the training data, such that features of interest are identified by machine learning using the reduced representation instead of the complete training data.

In some implementations, the features include an absolute energy E determined using each downhole temperature log. The feature extraction is performed for the first set of downhole temperature logs and the second set of downhole temperature logs. The absolute energy E of a downhole temperature log can be represented as in the following equation (1).

$$E = {\sum }_{i = 1 , … , n} {x}_{i}^{2} \qquad ( 1 )$$

Here, x represents a temperature reading, i represents an index of a temperature reading, and n represents a total number of temperature readings in a particular temperature log. In some implementations, the features include an absolute sum of temperature changes determined using the downhole temperature log. The feature extraction is performed for the first set of downhole temperature logs and the second set of downhole temperature logs. The absolute sum of temperature changes determined using the downhole temperature log can be represented as in the following expression (2).

$${\sum }_{i = 1 , … , n} \vert {x}_{i + 1} - {x}_{i} \vert \qquad ( 2 )$$

Here, x represents a temperature reading, i represents an index of a temperature reading, and n represents a total number of temperature readings in a particular temperature log.

In some implementations, the features include an aggregation R(l) of an autocorrelation function determined using the downhole temperature log. The autocorrelation function refers to a correlation of the measured temperatures with a delayed copy of the measured temperatures as a function of the time delay. The feature extraction is performed for the first set of downhole temperature logs and the second set of downhole temperature logs. The aggregation R(l) of the autocorrelation function can be represented as in the following equation (3).

$$R ( l ) = \frac{1}{( n - l ) {σ}^{2}} {\sum }_{t = 1}^{n - l} ( {X}_{t} - μ ) ( {X}_{t + l} - μ ) \qquad ( 3 )$$

Here, x represents a temperature reading, i represents an index of a temperature reading, n represents a total number of temperature readings in a particular temperature log, μ represents a mean temperature reading of a temperature log, σ² represents a variance determined from the temperature log, and l represents a time delay lag of the temperature log. The autocorrelation function itself is represented as in expression (4) as follows.

ƒ_{agg}( [symbol] (1), . . . , [symbol] (m)) for m=max(n,maxlag). (4)

In some implementations, the features include a linear least-squares regression determined from temperature values in a downhole temperature log. For example, the computer system can determine a least-squares approximation of a function represented by the downhole temperature values, including variants for ordinary (unweighted), weighted, and generalized (correlated) residuals. In some implementations, the feature extraction includes applying a vectorized approximate entropy algorithm to the downhole temperature values measured in the temperature logs. For example, the approximate entropy algorithm can be used to quantify an amount of regularity and unpredictability of fluctuations in the downhole temperature over time-series data. In some implementations, the feature extraction includes fitting an unconditional maximum likelihood of an autoregressive AR(k) process. Here, the k parameter represents a maximum time delay lag of the process. The autoregressive AR(k) process is used to describe the time-varying temperature values and the autoregressive model generated specifies that the output variable depends linearly on its own previous values and on a stochastic term. In some implementations, the feature extraction includes applying an augmented Dickey-Fuller hypothesis test to check whether a unit root is present in each downhole temperature log. A Dickey-Fuller test examines a null hypothesis that a unit root is present in an autoregressive model. In some implementations, the feature extraction includes determining a binned entropy of the downhole temperature logs. For example, the binned entropy determination can be used to estimate the differential entropy of the process based on histogram-based estimation. In some implementations, the feature extraction includes determining a corridor by multiple levels of quantiles dependent upon distribution of temperature values in a log. The average and absolute values of consecutive temperature changes of the temperature log inside the corridor is determined.

In some implementations, the features include a complexity metric of a downhole temperature log. The feature extraction is performed for the first set of downhole temperature logs and the second set of downhole temperature logs. The complexity metric of a downhole temperature log can be represented as in the following equation (5).

$$\sqrt{{\sum }_{i = 0}^{n - 2 lag} {( {x}_{i} - {x}_{i + 1} )}^{2}} \qquad ( 5 )$$

Here, x represents a temperature reading, i represents an index of a temperature reading, n represents a total number of temperature readings in a particular temperature log, and lag represents a time lag. In other implementations, the feature extraction includes determining a number of temperature values in a temperature log above a mean value or a number of temperature values in the log below the mean value.

In some implementations, the features include a Fourier transform performed on each downhole temperature log. The feature extraction is performed for the first set of downhole temperature logs and the second set of downhole temperature logs. For example, the computer system can determine a mean, a variance, a skew, or a kurtosis of an absolute Fourier transform. The kurtosis refers to a sharpness of a peak of a frequency-distribution curve. The computer system can determine Fourier coefficients of a one-dimensional discrete Fourier transform using a fast Fourier transformation algorithm as in the following equation (6).

$${A}_{k} = {\sum }_{m = 0}^{n - 1} {a}_{m} exp \{ - 2 π i \frac{mk}{n} \} , k = 0 , … , n - 1. \qquad ( 6 )$$

Here, Aₖ represents a value of the Fourier transform at a frequency k, n represents a total number of temperature readings in a particular temperature log, m represents a variable used to iterate over all temperature readings in a particular temperature log, and π represents the constant 3.14.

In some implementations, the feature extraction includes determining whether a value in a temperature log occurs more than once, whether a maximum value in the temperature log is observed more than once, or whether a minimum value in the temperature log is observed more than once. In some implementations, the feature extraction includes determining an index where a percentage of a mass of the temperature log lies to the left of the index, determining a kurtosis of the temperature log, or determining whether a standard deviation of the temperature log is higher than a percentage of the difference between the maximum and minimum values, expressed as in the following inequality (7).

std(x)>r*(max(X)−min(X)) (7)

Here, r represents a desired percentage value and x represents a temperature reading.

In some implementations, the feature extraction includes determining a length of a temperature log, determining a linear least-squares regression of the temperature log, determining a length of a longest consecutive subsequence in the temperature log that is larger than a mean value of the temperature log, determining a length of a longest consecutive subsequence in the temperature log that is smaller than the mean value of the temperature log, determining a maximum temperature value in the temperature log, or determining a mean temperature value of the temperature log. In some implementations, the feature extraction includes determining a mean over absolute differences between subsequent time series values as represented in the following expression (8).

$$\frac{1}{n} {\sum }_{i = 1 , … , n - 1} \vert {x}_{i + 1} - {x}_{i} \vert \qquad ( 8 )$$

Here, x represents a temperature reading, i represents an index of a temperature reading, and n represents a total number of temperature readings in a particular temperature log.

In some implementations, the feature extraction includes determining a mean value over the differences between subsequent time series values from the temperature logs. For example, the mean value can be determined using the following expression (9).

$$\frac{1}{n} {\sum }_{i = 1 , … , n - 1} {x}_{i + 1} - {x}_{i} \qquad ( 9 )$$

Here, x represents a temperature reading, i represents an index of a temperature reading, and n represents a total number of temperature readings in a particular temperature log. In other implementations, the feature extraction includes determining a mean value of a central approximation of a second derivative determined from the temperature logs as in the following expression (10).

$$\frac{1}{n} {\sum }_{i = 1 , … , n - 1} \frac{1}{2} ( {x}_{i + 2} - 2 \cdot {x}_{i + 1} + {x}_{i} ) \qquad ( 10 )$$

Here, x represents a temperature reading, i represents an index of a temperature reading, and n represents a total number of temperature readings in a particular temperature log.

In some implementations, the feature extraction includes determining a median value of a temperature log, a number of crossings of the temperature log for a particular temperature value, or a number of peaks having a particular support value. In some implementations, the feature extraction includes determining a value of a partial autocorrelation function at a particular time delay lag using the following equation (11).

$${α}_{k} = \frac{Cov ( {x}_{i} , {x}_{t - k} \vert {x}_{t - 1} , … , {x}_{t - k + 1} )}{Var ( {x}_{i} \vert {x}_{t - 1} , … , {x}_{t - k + 1} ) Var ( {x}_{k - k} \vert {x}_{t - 1} , … , {x}_{r - k + 1} )} \qquad ( 11 )$$

Here, α represents a value of the partial autocorrelation for a particular time delay lag, k, between the values in the temperature log, x represents a temperature reading, i represents an index of a temperature reading, t represents a value in the temperature log value at a particular depth, Cov represents a statistical covariance, and Var represents a statistical variance.

In some implementations, the feature extraction includes determining a percentage of unique values that are present in a temperature log more than once or a ratio of unique values that are present in the temperature log more than once. In some implementations, the feature extraction includes determining quantiles of a temperature log, observed temperature values within a particular interval, or a ratio of temperature values that are larger than r×std(x), that is, determining temperature values that are away from the mean value, where r represents an integer (such as 3 or 5) and x represents a temperature reading. In some implementations, the feature extraction includes determining a ratio of a number of unique temperature values to a number of temperature values, an entropy of a temperature log, or a sample skewness of a temperature log. In some implementations, the feature extraction includes determining a power spectrum of a temperature log at different frequencies, a sum of all temperature values in a time series that are present more than once, or a sum of temperature values across the temperature log. In some implementations, the feature extraction includes determining a Boolean variable denoting whether the distribution of a temperature log is symmetric using the following expression (12).

|mean(X)−median(X)|<r*(max(X)−min(X)) (12)

Here, X represents all the values in the temperature log (X={x₁, x₂, . . . , xₙ}), where n represents a total number of temperature readings in a particular temperature log, xᵢ represents a temperature at the i^{th} depth, and r represents a real number.

In some implementations, the features include a metric based on a comparative feature-based time-series classification represented by the following expression (13).

$$\frac{1}{n - 2 lag} {\sum }_{i = 0}^{n - 2 lag} {x}_{i + 2 \cdot lag}^{2} \cdot {x}_{i + lag} - {x}_{i + lag} \cdot {x}_{i}^{2} \qquad ( 13 )$$

Here, x represents a temperature reading, i represents an index of a temperature reading, n represents a total number of temperature readings in a particular temperature log, and lag represents a time lag. In other implementations, the feature extraction includes counting occurrences of a particular temperature value in a temperature log.

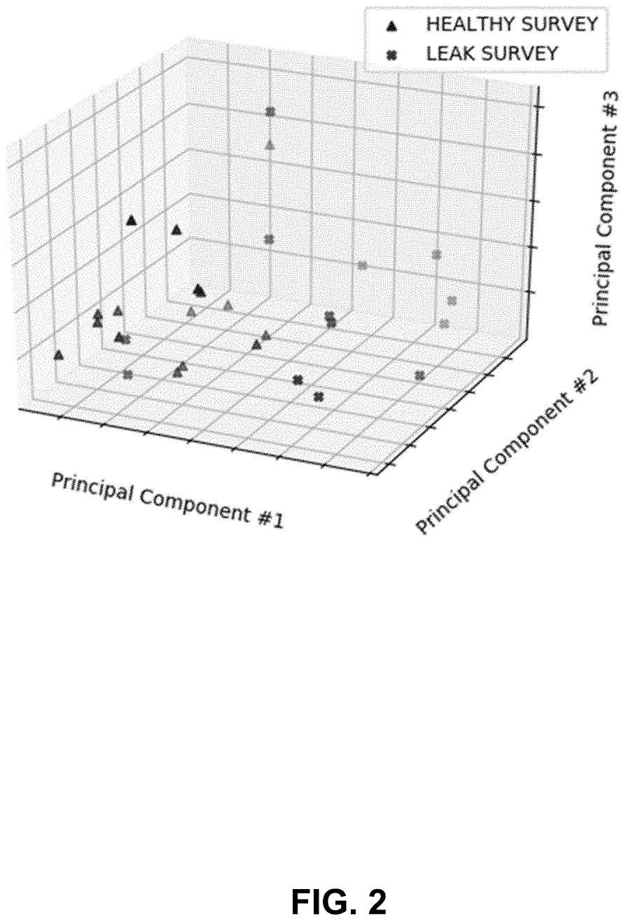

In the Dimensionality Reduction step illustrated in FIG. 1, the computer system applies a dimensionality reduction step (such as principal component analysis (PCA) to reduce the N dimensions of the feature space. For example, the computer system performs dimensionality reduction on the N-dimensional feature space to generate an M-dimensional feature space, where M is less than N. For example, M can be 3 or 4. The dimensionality reduction enables more efficient computation using the central processing unit (CPU) of the computer system. FIG. 2 illustrates a visualization of PCA used for dimensionality reduction. In some implementations, other dimensionality reduction methods can be used, such as independent component analysis, Isomap, Kernel PCA, latent semantic analysis, partial least squares, multifactor dimensionality reduction, nonlinear dimensionality reduction, multilinear principal component analysis, multilinear subspace learning, semidefinite embedding, Autoencoder, or deep feature synthesis.

In the Modeling step illustrated in FIG. 1, the computer system generates one or more machine learning models trained to determine one or more wellbore leaks in the multiple hydrocarbon wells based on the M-dimensional feature space. In the Modeling step, the computer system takes data points from the plane (illustrated in FIG. 2) having a reduced number of dimensions and applies machine learning to separate the healthy surveys (free of wellbore leaks) from the surveys indicating a wellbore leak. In some implementations, different types of machine learning models are used, such as neural networks, random forests, support vector machines, or logistic regression. In some experiments, the logistic regression model provided the most consistently accurate results.

In some implementations, once the machine learning models have been trained, the computer system extracts one or more features from a third set of downhole temperature logs obtained from a hydrocarbon well. The one or more features indicate a location of a wellbore leak in the hydrocarbon well. For example, the one or more features can include a location of a maximum temperature value in a temperature log or a location of a minimum temperature value in the temperature log. The one or more features can include the last location of the maximum temperature values in the temperature log or the last location of the minimum temperature values in the temperature log. The computer system determines a location of a wellbore leak in the hydrocarbon well using the one or more machine learning models based on the one or more features.

In the Evaluation step illustrated in FIG. 1, the computer system tests the different machine learning models to determine the level of performance. For example, the logistic regression model provided results as follows: Precision=0.80, Recall=0.89, F1 Score=0.84. Precision refers to a ratio of correctly predicted positive observations to the total predicted positive observations. Recall (Sensitivity) refers to a ratio of correctly predicted positive observations to all observations. The F1 score refers to a weighted average of Precision and Recall.

FIG. 2 illustrates a visualization of principal component analysis. The visualization illustrated in FIG. 2 shows the results of both feature extraction and dimensionality reduction to M=3 dimensions. The M-dimensional space is where the machine learning classification models are applied in the Modeling step, illustrated and described in greater detail with reference to FIG. 1. In some embodiments, the actual number of dimensions used in the classification space is 26.

FIG. 3 illustrates a process for wellbore leak determination. The process is described in greater detail with reference to FIG. 1. In some implementations the process of FIG. 3 is performed by a computer system.

The computer system receives (304) data obtained from multiple hydrocarbon wells. The data includes a first set of downhole temperature logs recorded before detection of one or more wellbore leaks in the multiple hydrocarbon wells, a second set of downhole temperature logs recorded after detection of the one or more wellbore leaks. In some implementations, a software module interfaces with the database to acquire the needed data. Custom-built data preprocessing techniques can be used to prepare the data for modeling.

The computer system extracts (308) multiple features from the data to generate an N-dimensional feature space. In some implementations, the computer system reduces redundancy in the training data (the received data obtained from the hydrocarbon reservoir) by transforming the training data into a reduced set of features (a feature vector). For example, in the Feature Extraction step, the computer system applies mathematical operations to the temperature logs to extract attributes (features). The feature vector contains the relevant information from the training data, such that features of interest are identified by machine learning using the reduced representation instead of the complete training data.

The computer system performs (312) dimensionality reduction on the N-dimensional feature space to generate an M-dimensional feature space, where M is less than N. In some implementations, unique dimensionality reduction techniques are configured to reduce computational power and time. FIG. 2 illustrates a visualization of PCA used for dimensionality reduction. In some implementations, other dimensionality reduction methods can be used, such as independent component analysis, Isomap, Kernel PCA, latent semantic analysis, partial least squares, multifactor dimensionality reduction, nonlinear dimensionality reduction, multilinear principal component analysis, multilinear subspace learning, semidefinite embedding, Autoencoder, or deep feature synthesis.

The computer system generates (316) one or more machine learning models trained to determine the one or more wellbore leaks in the multiple hydrocarbon wells based on the M-dimensional feature space. In some implementations, novel mathematical transformations are used for the inception of the models. The computer system takes data points from the plane (illustrated in FIG. 2) having a reduced number of dimensions and applies machine learning to separate the healthy surveys (free of wellbore leaks) from the surveys indicating a wellbore leak. In some implementations, different types of machine learning models are used, such as neural networks, random forests, support vector machines, or logistic regression. In some experiments, the logistic regression model provided the most consistently accurate results.

The methods described can be performed in any sequence and in any combination, and the components of respective embodiments can be combined in any manner. The machine-implemented operations described above can be implemented by a computer system that includes programmable circuitry configured by software or firmware, or a special-purpose circuit, or a combination of such forms. Such a special-purpose circuit can be in the form of, for example, one or more application-specific integrated circuits (ASICs), programmable logic devices (PLDs), field-programmable gate arrays (FPGAs), or system-on-a-chip systems (SOCs).

Software or firmware to implement the techniques introduced here can be stored on a non-transitory machine-readable storage medium and executed by one or more general-purpose or special-purpose programmable microprocessors. A machine-readable medium, as the term is used, includes any mechanism that can store information in a form accessible by a machine (a machine can be, for example, a computer, network device, cellular phone, personal digital assistant (PDA), manufacturing tool, or any device with one or more processors). For example, a machine-accessible medium includes recordable or non-recordable media (RAM or ROM, magnetic disk storage media, optical storage media, or flash memory devices).

The term “logic,” as used herein, means: i) special-purpose hardwired circuitry, such as one or more application-specific integrated circuits (ASICs), programmable logic devices (PLDs), field programmable gate arrays (FPGAs), or other similar device(s); ii) programmable circuitry programmed with software and/or firmware, such as one or more programmed general-purpose microprocessors, digital signal processors (DSPs) or microcontrollers, system-on-a-chip systems (SOCs), or other similar device(s); or iii) a combination of the forms mentioned in i) and ii).

What is claimed is:

1. A method comprising:
receiving, by a computer system, data obtained from a plurality of hydrocarbon wells, the data comprising:
a first plurality of downhole temperature logs recorded before detection of one or more wellbore leaks in the plurality of hydrocarbon wells; and
a second plurality of downhole temperature logs recorded after detection of the one or more wellbore leaks;
extracting, by the computer system, a plurality of features from the data to generate an N-dimensional feature space;
performing, by the computer system, dimensionality reduction on the N-dimensional feature space to generate an M-dimensional feature space, wherein M is less than N; and
generating, by the computer system, one or more machine learning models trained to determine the one or more wellbore leaks in the plurality of hydrocarbon wells based on the M-dimensional feature space.

2. The method of claim 1, wherein the plurality of features comprise, for each downhole temperature log of the first plurality of downhole temperature logs and the second plurality of downhole temperature logs, an absolute energy determined using the downhole temperature log.

3. The method of claim 1, wherein the plurality of features comprise, for each downhole temperature log of the first plurality of downhole temperature logs and the second plurality of downhole temperature logs, an absolute sum of temperature changes determined using the downhole temperature log.

4. The method of claim 1, wherein the plurality of features comprise, for each downhole temperature log of the first plurality of downhole temperature logs and the second plurality of downhole temperature logs, an aggregation of an autocorrelation function determined using the downhole temperature log.

5. The method of claim 1, wherein the plurality of features comprise, for each downhole temperature log of the first plurality of downhole temperature logs and the second plurality of downhole temperature logs, a complexity metric of the downhole temperature log.

6. The method of claim 1, wherein the plurality of features comprise, for each downhole temperature log of the first plurality of downhole temperature logs and the second plurality of downhole temperature logs, a Fourier transform performed on the downhole temperature log.

7. The method of claim 1, further comprising:
extracting, by the computer system, one or more features from a third plurality of downhole temperature logs obtained from a hydrocarbon well, the one or more features indicating a location of a wellbore leak in the hydrocarbon well; and
determining, by the computer system, the location of the wellbore leak using the one or more machine learning models based on the one or more features.

8. A non-transitory computer-readable storage medium storing instructions executable by one or more computer processors, the instructions when executed by the one or more computer processors cause the one or more computer processors to:
receive data obtained from a plurality of hydrocarbon wells, the data comprising:
a first plurality of downhole temperature logs recorded before detection of one or more wellbore leaks in the plurality of hydrocarbon wells; and
a second plurality of downhole temperature logs recorded after detection of the one or more wellbore leaks;
extract a plurality of features from the data to generate an N-dimensional feature space;
perform dimensionality reduction on the N-dimensional feature space to generate an M-dimensional feature space, wherein M is less than N; and
generate one or more machine learning models trained to determine the one or more wellbore leaks in the plurality of hydrocarbon wells based on the M-dimensional feature space.

9. The non-transitory computer-readable storage medium of claim 8, wherein the plurality of features comprise, for each downhole temperature log of the first plurality of downhole temperature logs and the second plurality of downhole temperature logs, an absolute energy determined using the downhole temperature log.

10. The non-transitory computer-readable storage medium of claim 8, wherein the plurality of features comprise, for each downhole temperature log of the first plurality of downhole temperature logs and the second plurality of downhole temperature logs, an absolute sum of temperature changes determined using the downhole temperature log.

11. The non-transitory computer-readable storage medium of claim 8, wherein the plurality of features comprise, for each downhole temperature log of the first plurality of downhole temperature logs and the second plurality of downhole temperature logs, an aggregation of an autocorrelation function determined using the downhole temperature log.

12. The non-transitory computer-readable storage medium of claim 8, wherein the plurality of features comprise, for each downhole temperature log of the first plurality of downhole temperature logs and the second plurality of downhole temperature logs, a complexity metric of the downhole temperature log.

13. The non-transitory computer-readable storage medium of claim 8, wherein the plurality of features comprise, for each downhole temperature log of the first plurality of downhole temperature logs and the second plurality of downhole temperature logs, a Fourier transform performed on the downhole temperature log.

14. The non-transitory computer-readable storage medium of claim 8, the instructions further causing the one or more computer processors to:
extract one or more features from a third plurality of downhole temperature logs obtained from a hydrocarbon well, the one or more features indicating a location of a wellbore leak in the hydrocarbon well; and
determine the location of the wellbore leak using the one or more machine learning models based on the one or more features.

15. A computer system comprising:
one or more computer processors; and
a non-transitory computer-readable storage medium storing instructions executable by the one or more computer processors, the instructions when executed by the one or more computer processors cause the one or more computer processors to:
receive data obtained from a plurality of hydrocarbon wells, the data comprising:
a first plurality of downhole temperature logs recorded before detection of one or more wellbore leaks in the plurality of hydrocarbon wells; and
a second plurality of downhole temperature logs recorded after detection of the one or more wellbore leaks;
extract a plurality of features from the data to generate an N-dimensional feature space;
perform dimensionality reduction on the N-dimensional feature space to generate an M-dimensional feature space, wherein M is less than N; and
generate one or more machine learning models trained to determine the one or more wellbore leaks in the plurality of hydrocarbon wells based on the M-dimensional feature space.

16. The system of claim 15, wherein the plurality of features comprise, for each downhole temperature log of the first plurality of downhole temperature logs and the second plurality of downhole temperature logs, an absolute energy determined using the downhole temperature log.

17. The system of claim 15, wherein the plurality of features comprise, for each downhole temperature log of the first plurality of downhole temperature logs and the second plurality of downhole temperature logs, an absolute sum of temperature changes determined using the downhole temperature log.

18. The system of claim 15, wherein the plurality of features comprise, for each downhole temperature log of the first plurality of downhole temperature logs and the second plurality of downhole temperature logs, an aggregation of an autocorrelation function determined using the downhole temperature log.

19. The system of claim 15, wherein the plurality of features comprise, for each downhole temperature log of the first plurality of downhole temperature logs and the second plurality of downhole temperature logs, a complexity metric of the downhole temperature log.

20. The system of claim 15, wherein the plurality of features comprise, for each downhole temperature log of the first plurality of downhole temperature logs and the second plurality of downhole temperature logs, a Fourier transform performed on the downhole temperature log.
